(19) United States
(12) Patent Application Publication
(10) Pub. No.: US 2007/0182625 A1
(43) Pub. Date: Aug. 9, 2007

(54) Gps device

(75) Inventors: Kanji Kerai, London (GB); Robert Nicholas, Hook (GB); James Scales, Berkshire (GB); Marko E. Leinonen, Oulu (FI)

Correspondence Address: FOLEY & LARDNER LLP, 321 NORTH CLARK STREET, SUITE 2800, CHICAGO, IL, 60610-4764, US

(73) Assignee: Nokia Corporation

(21) Appl. No.: 10/584,715

(22) PCT Filed: Dec. 29, 2004
(86) PCT No.: PCT/IB04/04298

§ 371 Date: Apr. 27, 2007

(30) Foreign Application Priority Data
Dec. 30, 2003 (GB) 0330192.6

(51) Int. Cl. G01S 5/14; H04Q 7/20; H04M 1/00

(52) U.S. Cl. 342/357.1; 455/456.1; 455/552.1

(57) ABSTRACT

A combination of a GPS device and an adjacent mobile communications device. The mobile communications device comprises: a wireless communications transceiver comprising means for receiving at least one of timing information and location information. The GPS device comprises: a receiver for receiving at least one GPS signal, a positional estimator for providing a positional estimate in dependence of said received at least one GPS signal and said at least one of timing information and location information.

### FIELD OF THE INVENTION

The present invention relates to a GPS device, in particular but not exclusively for use in a communications system for determining a location in a cellular wireless system.

### BACKGROUND OF THE INVENTION

Wireless cellular communication networks and their operation are generally well known. In such a system the area covered by the network is divided into cells. Each cell is provided with a base station, which is arranged to communicate with a plurality of mobile stations or other user equipment in a cell associated with the base station.

In these known systems, it is possible to locate a mobile station with reference to a base station, and therefore possible to locate a mobile station within the operational transmission range of a base station.

As is also known additional location information can be determined by measuring the time between transmission and reception of a signal between a mobile station and a known base station or transmitter. Using such time of arrival (TOA) methods with signals transmitted from base stations it is possible to locate a mobile station within tens of metres.

Using the base station to transmit timing signals and using these signals to determine a positional estimate produces an estimate containing several potential errors and problems. One of the major problems is the many different paths that the transmissions from the base station to the mobile station can take. The path can be direct, which provides an accurate estimation of the distance between the base and mobile stations or the path can be diffracted or reflected by man-made or natural phenomena such as buildings, large vehicles and hills. These indirect paths do not reflect the true distance between the base station and the mobile station and therefore produce location estimation errors. These diffracted and reflected signal paths occur more frequently in built-up and urban environments, thus degrading the more accurate base station location estimations due to the increased density of base stations.

A separate development in location estimation has been the development of a global positioning satellite (GPS) system which enables a GPS receiver to accurately locate its position within a couple of metres by measuring the time differences between received signals from satellites orbiting the earth. The GPS system relies on both the transmitter (the orbiting satellites) and the receiver to have accurate knowledge of a transmitted timing sequence signal in order that an accurate estimation of the position of the receiver can be made.

As is known in the art the GPS orbiting satellites are accurately synchronised each carrying an accurate very stable atomic clock. Furthermore the constellation of satellites are monitored from controlling ground stations and any timing errors detected are effectively corrected.

As the cost of supplying each GPS receiver with an accurate and stable clock oscillator such as an atomic clock is prohibitive, the typical GPS receiver determines an accurate GPS time sequence by comparing at least four separate GPS timing signals received from at least four different satellites. These satellites are used to both accurately synchronise the receiver clock and to provide an accurate estimation of the location of the signal.

The process of locating four of these timing sequences and fixing accurately the receiver clock is performed by a timing synchronisation sequence.

As it is known in the art a timing synchronisation sequence can be carried out by receiving the Time of Week (ToW) signal transmitted by each GPS satellite. The ToW signal is transmitted once per GPS subframe, in other words exactly every six seconds. The detection of the ToW signal is largely dependent on the received strength of the signal, and below a certain threshold it becomes impossible to decode the information bits that go to make up the ToW signal. Additionally, processing the ToW signal takes up a significant amount of processing time which has an adverse impact on power consumption.

As is further known in the art, cellular mobile stations may be equipped with GPS receiver modules in order to improve the location estimation capacity of the mobile station.

The cost of equipping a cellular mobile station with such a GPS receiver however raises the cost of production of the mobile station, increases the physical volume of the mobile station and decreases the battery life.

Furthermore many current cellular mobile station designs are not equipped with GPS receivers but require location estimation in order to provide the cellular network data to perform network location services.

### SUMMARY OF THE INVENTION

It is an aim of the embodiments of the present invention to address or partially mitigate one or more of the problems discussed previously.

There is provided according to the invention a combination of a GPS device and an adjacent mobile communications device wherein said mobile communications device comprises: a wireless communications transceiver comprising means for receiving at least one of timing information and location information, and said GPS device comprises: a receiver for receiving at least one GPS signal, a positional estimator for providing a positional estimate in dependence of said received at least one GPS signal and said at least one of timing information and location information.

According to a second aspect of the present invention there is provided a GPS device comprising: a first receiver for receiving at least one first signal; a GPS positional estimator for providing a positional estimate dependent on said received at least one first signal; and a wireless communications transceiver comprising means for directly transmitting said positional estimate over a first communications medium to an adjacent device.

The adjacent device may be a mobile communications device comprising: a wireless communications transceiver comprising means for receiving said positional estimate over said first medium.

The mobile device may further comprise a display for displaying said received positional estimate to the user.

The mobile device may further comprise a further wireless communications transceiver comprising means for communicating over a cellular telecommunications network.

The mobile communications device further wireless transceiver may be arranged to transmit said positional estimates over said cellular telecommunications network.

The mobile communications device may further comprise means for receiving at least one of timing information and location information from said cellular telephone network.

The at least one of said communications device and said GPS device may be arranged to provide a position estimate based on said at least one of said timing information and said location information.

The combination may further comprise a memory, wherein said positional estimates are stored in said memory.

The mobile communications device wireless transceiver may be arranged to transmit at least one of the positional estimates stored in said memory over said cellular telecommunications network.

The wireless transceiver may be arranged to communicate over an enhanced synchronised connection orientated (eSCO) communication channel.

The wireless transceiver may be at least one of: a Bluetooth transceiver; a IrDA transceiver; a IEE 802.11 transceiver.

The at least one timing information and location information from said cellular telephone network second signal may comprise at least one of: a base transceiver station timing signal; a base transceiver station positional estimate.

According to a third aspect of the present invention there is provided a GPS device comprising: a first receiver for receiving at least one first signal; a GPS positional estimator for providing a positional estimate dependent on said received at least one first signal; and a communications transceiver for directly transmitting said positional estimate over a wired communication link to said mobile communications device, said mobile device comprising: a communications transceiver comprising means for receiving said positional estimate via said wired communication link, and wherein said GPS device is connected to said mobile communications device by said wired link.

The GPS device may further comprise a connector and said mobile device may further comprise a connector, wherein said GPS device connector may be physically connected to said mobile device connector and said connection forms said wired link between said GPS device and said mobile device.

The wired link may be arranged to transmit at least one of: an information signal; a power supply.

The mobile device may further comprise a further wireless communications transceiver comprising means for communicating over a cellular telecommunications network.

The mobile communications device may further comprise means for receiving at least one of timing information and location information from said cellular network

The at least one timing information and location information from said cellular telephone network second signal may comprise at least one of: a base transceiver station timing signal; a base transceiver station positional estimate.

The mobile communications device further wireless transceiver may be at least one of: a GSM transceiver; a WCDMA transceiver; a UMTS transceiver; a CDMA2000 transceiver.

The combination may further comprise an indicator, said indicator may comprise at least one of: at least one LED; a buzzer.

The combination may further comprise a switch arranged to switch said GPS device on and off.

The combination may further comprise a battery arranged to provide a power source for said GPS device.

The first receiver may be a GPS receiver and said first signal may be a GPS signal.

According to a fourth aspect of the present invention there is provided a method of providing a GPS estimate comprising the steps of: receiving at least one first signal on a GPS device; determining a positional estimate dependent on said received one signal on said GPS device; transmitting said positional estimate over a wireless communications link to a mobile device, said mobile device being located at substantially the same location as the GPS device.

The method may further comprise the steps of: receiving said positional estimate on said mobile device via said communications link, said mobile device being located at substantially the same location as the GPS device; displaying said positional estimate on said mobile device.

The method may further comprise the steps of: receiving a second signal on said mobile device from a cellular telecommunications system; producing a third signal dependent on said second signal; transmitting said third signal over a wireless communications link to said GPS device; wherein said step of determining said positional estimate is further dependent on third signal.

The method may further comprise said steps of; storing said positional estimates in a memory; transmitting said stored positional estimated over said cellular telecommunications system.

### BRIEF DESCRIPTION OF DRAWINGS

For a better understanding of the present invention and how the same may be carried into effect, reference will now be made by way of example only to the accompanying drawings in which:

FIG. 1 shows a schematic view of a communications system with location estimation capability, embodying the present invention;

FIG. 2 shows a detailed schematic view of user equipment and GPS receiver as shown in FIG. 1, in which embodiments of the present invention can be implemented;

FIG. 3 shows a flow diagram view of the method used in the embodiment of the present invention as shown in FIG. 2.

### DETAILED DESCRIPTION OF EMBODIMENTS

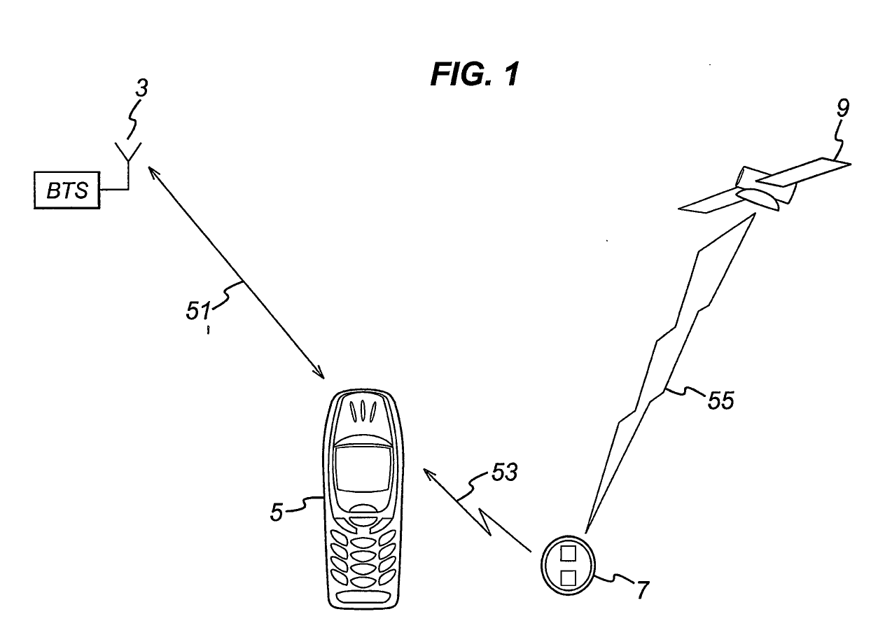

Reference is made to FIG. 1, which shows part of a cellular telecommunications network embodying the present invention. The area covered by the network is divided into a plurality of cells (which are not shown). Each cell has associated therewith a base transceiver station 3. The base transceiver station is also known as a base station. The base transceiver station 3 is arranged to communicate with mobile devices or other user equipment 5 associated with the base transceiver station 3. Examples of mobile devices include mobile telephones, personal digital assistants (PDA) with transceiver capabilities, and laptops with transceiver capabilities. These mobile devices 5 are also known as mobile stations.

The cells may overlap at least partially or totally. In some embodiments the base transceiver stations may communicate with mobile devices 5 outside their associated cell. In other embodiments mobile devices 5 may communicate with other mobile devices 5 directly and without recourse to the base transceiver station 3. In other embodiments of the invention base transceiver station 3 may communicate with another base transceiver station 3 directly.

Communication between the mobile device 5 and the base transceiver station 3 within a cell is synchronised to both the symbol and frames transmitted by the base transceiver station 3. As is known in the art the base transceiver station 3 derives its timing from a clock accurate and stable to within a fraction of a part per million. The mobile device 5 receives the base transceiver station signals and uses the base transceiver station signals to synchronise its own internal clock and timings.

As is known in the art, Code Division Multiple Access (CDMA) network standards used in the United States are synchronised with the Global Positioning System (GPS) timing sequence, other communication standards such as the Global System for Mobile Communications (GSM) and Wideband Coded Division Multiple Access (WCDMA) do not provide a base station timing synchronised GPS time, and are therefore considered asynchronous with respect to GPS time. Furthermore the base stations and their timing can be considered asynchronous to one another.

With respect to FIG. 1 a single base transceiver station 3 is shown. The base transceiver station 3 communicates via the communication link 51 with the mobile station 5. In FIG. 1 the mobile device 5 is shown to be a mobile phone.

FIG. 1 also shows a schematic view of a typical GPS system. A GPS receiver 7 uses an antenna (not shown) to receive signals 55 from orbiting satellites 9. In FIG. 1 the GPS receiver 7 is shown with one of the constellation of orbiting satellites transmitting GPS signals. In practice a GPS receiver may be required to receive signals from more than one of the constellation of orbiting satellites in order to acquire an accurate location estimate. Each of the satellites 9 transmits a signal made up of frames. Each frame is made up of sub-frames comprising a 50 bit per second data sequence.

This 50 bit per second data sequence comprises a known preamble, a Time Of Week (ToW), and a sub-frame ID. The preamble is a predetermined eight bit identifier at the beginning of every sub-frame, and a two bit (00) sequence at the end of every sub-frame, which is the same for all of the satellites. The Time of Week signal is a 17 bit sequence which accurately defines the time of the start of the current sub-frame.

In order that this signal is capable of being received at very low power levels and still being extracted from the background noise the data sequence is modulated using a know pseudo random timing sequence. This pseudo random sequence is also known as the gold code and is 1023 bits long and is transmitted at 1.023 MHz, in other words the code sequence repeats 20 times per data bit. As this high frequency signal is coherent with the bit stream it can be possible to produce an accurate timing estimate and hence positional estimate if one is able to identify/detect the start of a bit edge, and in addition one knows exactly to which bit the data bit sequence the date detected edge belongs.

The knowledge of exactly to which bit within the data bit sequence the detected edge bit belongs to can be determined using knowledge of the GPS system. As is known in the art it is possible to use the GPS almanac in order to determine at any specific time where the GPS satellites are currently located and therefore the approximate time delay of the received bit within a limit. So using a rough GPS time value and knowledge of the location of the GPS satellite it is possible to determine that the received bits from each of the GPS satellites are specific received bits.

The location estimate of the GPS receiver using the typical GPS system is carried out using a process known as triangulation. This process assumes that a time signal stored by the GPS receiver 7 and the orbiting satellite 9 is accurately synchronised. The pseudo random timing sequence is transmitted repeatedly from the satellite 9 and received by the GPS receiver 7. The GPS receiver 7 then compares the received sequence against the expected sequence in order to determine a timing delay. Using this timing delay and the accurately known position of the satellite, the GPS receiver estimate prescribes a spherical arc along which the GPS receiver is estimated to be. It is the combination of these arcs that provide an accurate positional estimate. If three satellites can be seen the three arcs intersect at two points. If four or more satellites are seen then the arcs intersect at a single location—providing a single positional estimate in three dimensional space. In other words the positional estimate is capable of providing a latitude, longitude and elevation estimate.

FIG. 1 further shows a communications link between the mobile device 5 and the GPS receiver 7. The communications link 53 in a first embodiment of the present invention is a Bluetooth low power radio frequency link.

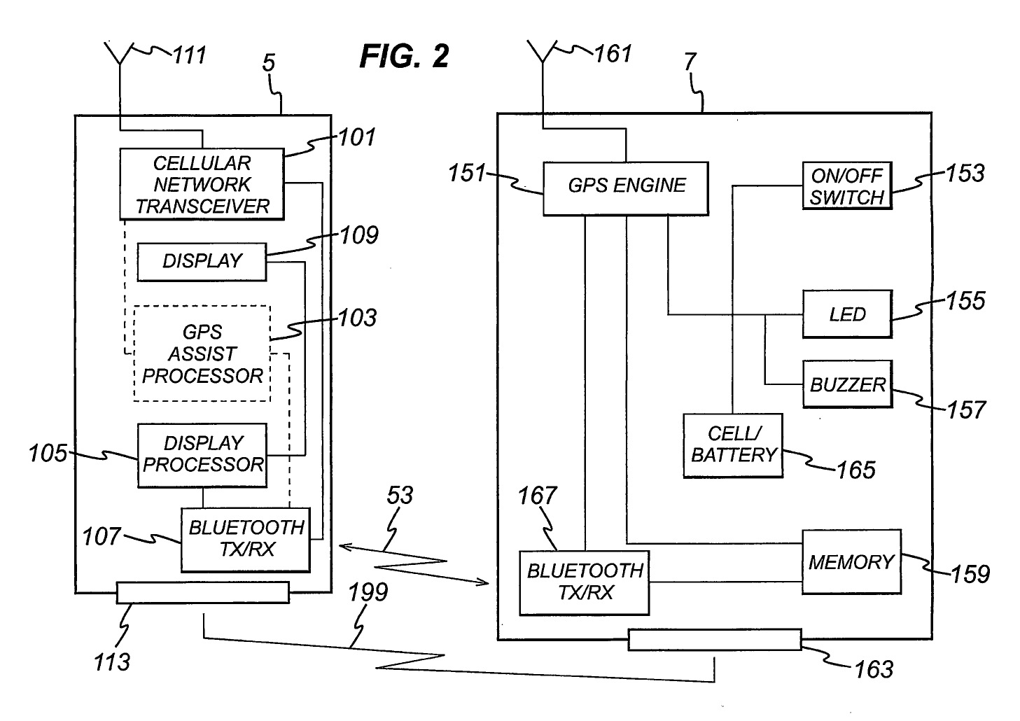

With respect to FIG. 2 a detailed schematic view of the mobile device 5 and GPS receiver 7 as embodied in the present invention is shown. The mobile station/GPS receiver comprises a mobile device 5, a GPS receiver 7, and a communications link 53.

The communications link 53 connects the mobile device 5 and the GPS receiver 7, enabling the transfer of data between the two units.

The mobile device 5 comprises a cellular receiving antenna 111, a cellular network transceiver 101, a Bluetooth transceiver 107, a display processor 105, and a display 109. The mobile device 5 may comprise further components that are used in order that the mobile device be used as required and known in the art, these components though have been omitted in order to simplify the description of the invention. In a further embodiment of the present invention the mobile device further comprises a GPS assist processor 103

The cellular network antenna 111 is connected to the cellular network transceiver 101 in order that the mobile device 5 is able to communicate with the cellular network via the base transceiver station 3.

The cellular network transceiver is connected to the Bluetooth transceiver. The Bluetooth transceiver is further connected to the display processor 105. The display processor 105 is connected to the display 109.

In the further embodiment where the mobile device further comprises a GPS assist processor 103 the cellular network transceiver 101 is further connected to the GPS assist processor 103. In the same embodiment the GPS assist processor 103 is further connected to the Bluetooth transceiver 107

The cellular network transceiver 101 receives and transmits data to the base transceiver station 3 according to the protocols and communication system characteristics as known in the art. Its role in the embodiments of the invention is receiving timing and possible positional assist information from the base transceiver station 3, and transmitting GPS information relating to the handset to the base transceiver station 3 for network services.

In FIG. 2 the cellular network transceiver is shown with the optional GPS assist processor (the GPS assist processor being marked by the dotted box). The GPS assist processor 103 is able to receive timing information or approximate positional information as is known in the art, from the base transceiver station over the cellular network communication link. The GPS assist processor processes this information in order to produce GPS assist data that can be used by the GPS receiver 7 to produce better or quicker estimates of the position. This GPS assist data is then passed to the Bluetooth transceiver 107.

A further embodiment of the invention is where the GPS assist processor is located within the GPS receiver. In such an embodiment (not shown in the diagram) the cellular transceiver 101 passes the received timing or approximate positional data to the GPS device where the GPS assist processor produces GPS assist data which is used by the GPS receiver 7 to produce better or quicker estimates.

The Bluetooth transceiver 107 can connect to the GPS receiver 7 via the Bluetooth communication link 53 using an enhanced synchronised connection orientated (eSCO) channel. As is known in the art the Bluetooth communications system uses a low power radio frequency signal, typically in the order of mW transmitted power, to communicate between user equipment. It can have a range of up to approximately 100 m and is capable of transmitting data rates of approximately 1 Mbit per second with an omni-directional transmission pattern. The latest specification of which is version 1.2 which can be found on the bluetooth web site at the address: https://www.bluetooth.org/foundry/adopters/document/Bluetooth Core Specification v1.2. The specification document is hereby incorporated by reference. The enhanced synchronised connection orientated (eSCO) data link as known is provided for as part of the standards implementing Bluetooth version 1.2. In such a link a first and second device are connected in such a way that the devices communicate to each other using “fixed” delay communication channels.

The eSCO channel communication system allows both the master and slave devices to determine when the information was sent and therefore any transmission delay may be accounted for.

The GPS receiver 7 comprises a GPS receive antenna 161, a GPS engine 151, and a Bluetooth transceiver 167. The GPS receive antenna 161 is connected to the GPS engine 151. The GPS engine is connected to the Bluetooth transceiver 167.

In further embodiments of the present invention the GPS receiver 7 may further comprise an On/Off switch 153, a light emitting diode indicator (LED) 155, a buzzer 157, a memory 159, and an internal cell or battery 165.

As shown in FIG. 2 all of the components described are shown. The GPS engine 151 is connected to the LED indicators 155 and the buzzer 157. The On/Off switch 153 is shown connected to the internal cell/battery 165. The GPS engine 151 is connected to memory 159. The memory is further connected to the Bluetooth transceiver 167.

As will be understood by the skilled person the cell/battery 165 is connected to all of the components requiring a power source in the GPS receiver. These connections are omitted in FIG. 2 in order to aid the understanding of the figure.

The On/Off switch 153 is used to preserve the lifetime of the internal cell battery 165 by allowing the operator of the GPS receiver to switch it off during periods where no estimation is required. This is shown in FIG. 2 by the connection from the on/off switch 153 to the cell/battery 165. As will be understood by the skilled man there are several methods of providing the functionality of the on/off switch in order to disconnect the cell/battery 165 from the GPS receiver components in order to preserve cell/battery life.

The indicator LEDs 155 can be used in embodiments of the present invention to provide a visual indication of events occurring in the GPS receiver. Examples of events include a low battery condition, a power on condition, or that a GPS fix has been achieved. The LEDs in some embodiments can be small dual colour LEDs.

The buzzer 157 can be provided in some embodiments of the invention to provide an audible warning indicator to assist or replace the visual indications provided by the indicator LEDs 155.

The GPS engine 151 is a GPS data processor and receiver capable of receiving GPS timing signals from the GPS antenna 161 and producing an estimate of the position of the GPS receiver 7. As is known in the art the GPS engine 151 can further comprise memory (not shown) additional to and external to the processor to assist in the estimation.

In some embodiments of the present invention the GPS engine can receive additional positional information from the GPS assist processor of the mobile device 5 via the Bluetooth communication link 53 in order to produce a positional assisted GPS positional estimate.

In further embodiments of the present invention the GPS engine receives from the GPS assist processor 103 of the mobile device 5 via the Bluetooth communication link 53 timing information in order that the GPS engine is able to produce an improved time to estimation.

In a separate embodiments of the present invention the GPS receiver 7 may comprise in addition to/or instead of the Bluetooth transceiver a communications port 163. The communications port 163 is connected in this embodiment of the invention to the memory 159 and GPS engine 151. Furthermore the mobile device in such embodiments of the present invention further comprises in addition to/or instead of the Bluetooth transceiver 107 a communications port 113. The mobile device communications port 113 is connected to the display processor 107 and the cellular transceiver 101. In further embodiments the mobile device communications port 113 is connected to the GPS assist processor 103.

The mobile device communications port 113 can be connected to the GPS receiver communications port 163 via a fixed communication link 199. In some embodiments of the present invention the fixed communications link 199 can be a wire or cable conducting signals between the mobile device 5 and the GPS receiver 7. In other embodiments of the present invention the fixed communications link can be formed by directly connecting the mobile device communications port 113 to the GPS receiver communications port 163. In some embodiments of the present invention the mobile device communications port can be positioned at the bottom end of the mobile device, with the GPS receiver 7 therefore physically attached to the bottom of the mobile device 5.

The fixed communications link 199 can be used to pass data similar to that passed via the Bluetooth communications link 53, for example positional data from the GPS receiver to the mobile device.

In these embodiments of the present invention the mobile device 5 can alternatively or additionally supply the GPS receiver 7 with power via the fixed communications link 199 should the GPS receiver 7 require an additional source of power.

In further embodiments of the present invention the memory 159 can be used to store positional information of the GPS receiver. The positional information is stored in some embodiments of the invention after a predetermined time period. The positional information is stored in some embodiments of the present invention if the positional estimate differs significantly from a previous estimate, or if the estimate is outside a predefined range of values.

The positional information stored in the memory can then be sent to the mobile device 5 via the Bluetooth communication link 53, or other communication links, such as the fixed link 199, or other wireless communication links as known in the art in order that the positional information can be transmitted via the cellular network to a central storage unit (not shown).

This type of embodiment of the present invention can be used in such applications as vehicle tracking, child journey tracking, or in tracking or tagging criminal offenders.

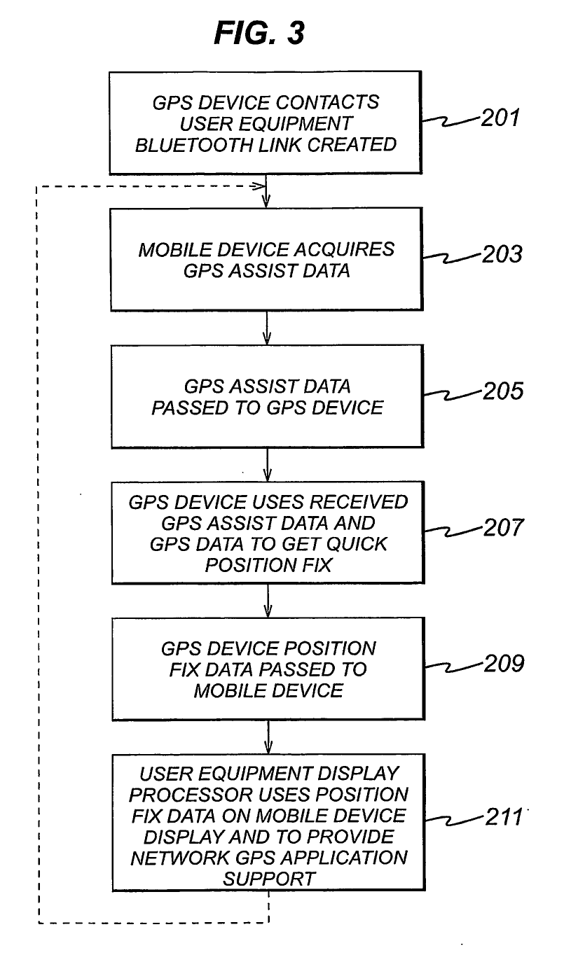

With reference to FIG. 3 a flowchart of the method of operation of the GPS receiver 7 and the mobile station 5 as used in embodiments of the present invention are shown. Where there is no GPS assist processor in the mobile device or the GPS receiver, the options are described.

In a first step 201 the GPS receiver contacts the user equipment via the Bluetooth link 53.

Once the Bluetooth link 53 has been established the step 203 is carried out. If there is no GPS assist processor then the method passes to step 207.

If there is a GPS assist processor then in step 203, the mobile device 5 acquires GPS assist data in order to aid the GPS receiver 7 in producing a more accurate positional estimate, or a faster time to estimate as described previously.

If the GPS assist processor is within the mobile device 5 then the GPS processor produces the data to be used by the GPS engine and passes it to the Bluetooth transceiver 107, the method passes to step 205. If the GPS assist is elsewhere the cellular network transceiver 101 passes the raw cellular assist data to the Bluetooth transceiver 107, the method then passing to step 205.

Once data has reached the Bluetooth transceiver 107, the Bluetooth transceiver 107, in step 205, transmits the data via the Bluetooth communications link 53 to the GPS receiver 7.

In the next step 207, the GPS receiver 7 uses the received GPS data from the satellites as received by the GPS receiver antenna 161 in order to produce a position fix. In an embodiment where the GPS assist processor is within the mobile device the GPS engine can use the additional data to produce a quicker or more accurate estimate. Where the GPS assist processor is in the GPS receiver, the raw assist data is processed and the processed data passed to the GPS engine 151 to produce a quicker or more accurate positional estimate.

The GPS engine 151 of the GPS receiver then passes the position fix data, in step 209, to the GPS receiver Bluetooth transceiver 167. The GPS estimate is transmitted via the Bluetooth communications link 53 to the Bluetooth transceiver 107 of the mobile device 5.

In the following step 211, the mobile device 5 receives the position fix data and passes the data to the display processor in order that it may be configured for displaying on the mobile device display 109. Furthermore the data may be passed to the cellular network transceiver 101 of the mobile device 5 for transmitting to the cellular network in order to provide network GPS application support.

It can therefore be seen that the combination of the GPS receiver and the mobile station in such embodiments of the invention enable the GPS device to be kept to a small size since there is no requirement for a display on the GPS receiver. The mobile station itself can be kept to a small size not requiring the additional processing or memory in order to perform the GPS positional estimation calculations or contain the GPS receiving antennas.

Furthermore as the connection between the GPS receiver and the mobile station is via the Bluetooth communications link the same GPS receiver can be used on more than one mobile station.

As would be understood by the skilled man, although the wireless communications link between the GPS receiver and the mobile device are described as being a Bluetooth communications link, alternative wireless communications systems such those obeying the standards provided in IEEE 802.11 and IrDA, the document standards of which are hereby incorporated by reference, could be used.

In other embodiments of the present invention the GPS receiver 7 can be contacted by more than one mobile device at substantially the same location in order that more than one mobile device can be provided with a positional estimate.

In further embodiments of the present invention the GPS receiver can further comprise a controller capable of switching the GPS receiver into a dormant mode of operation in order to conserve battery power. The controller can switch to this dormant mode when a predetermined time period has passed and there has been no request for positional estimation information from the mobile device. The GPS receiver in further embodiments can be restored to its active mode following a request for positional estimation information from the mobile device.

1-30. (canceled)

31. A mobile communications device comprising:
a wireless transceiver comprising means for receiving at least one of timing information and location information from a cellular communications network, and
a second wireless transceiver comprising means for transmitting said at least one of the said timing information and location information to an adjacent GPS device.

32. A GPS device comprising:
a GPS receiver comprising means for receiving a GPS signal;
a wireless transceiver comprising means for receiving from an adjacent device at least one of timing information and location information; and
a GPS positional estimator for providing a positional estimate dependent on said received GPS signal and at least one of the said timing information and location information.

33. A GPS device as claimed in claim 32, in combination with said adjacent device, the adjacent device being a mobile communications device, the mobile communications device comprising a wireless transceiver comprising means for receiving at least one of the said timing information and location information from a cellular communications network.

34. A combination as claimed in claim 33, wherein the mobile communications device further comprises a second wireless communications transceiver comprising means for transmitting said at least one of the said timing information and location information to an adjacent GPS device.

35. A combination of the mobile communications device as claimed in claim 31 and a GPS device, wherein the GPS device comprises a GPS communications receiver for receiving a GPS signal.

36. A combination as claimed in claim 35, wherein the GPS device further comprises a wireless transceiver for receiving the at least one of the said timing information and location information from the adjacent mobile communications device.

37. A combination as claimed in claim 36, wherein the GPS device further comprises a GPS positional estimator for providing a positional estimate dependent on the received GPS signal and at least one of the said timing information and location information.

38. A combination as claimed in claim 33 wherein the GPS device wireless transceiver further comprises means for directly transmitting said positional estimate to the mobile communications device.

39. A combination as claimed in claim 38 wherein the mobile communications device further comprises:
the second wireless transceiver comprising means for receiving the said positional estimate.

40. A combination as claimed in claim 39, wherein the mobile device further comprises a display for displaying said received positional estimate to the user.

41. A combination as claimed in claims 39, wherein said mobile communications device wireless transceiver is arranged to transmit the received positional estimates over said cellular communications network.

42. A combination as claimed in claim 33, wherein said communications device is arranged to provide a position estimate based on the at least one of the said timing information and said location information.

43. A combination as claimed in claim 33, further comprising a memory, wherein said positional estimates are stored in said memory.

44. A combination as claimed in claim 43, wherein said mobile communications device wireless transceiver is arranged to transmit at least one of the positional estimates stored in said memory over said cellular communications network.

45. A combination as claimed in claim 34, wherein the GPS wireless transceiver and the mobile communications device second wireless transceiver are arranged to communicate between each other over an enhanced synchronised connection orientated (eSCO) communication channel.

46. A combination as claimed in claim 34, wherein the GPS wireless transceiver and the mobile communications device second wireless transceiver are arranged to communicate between each other over a synchronised short range wireless communication channel.

47. A combination as claimed in claim 34, wherein the GPS wireless transceiver and the mobile communications device second wireless transceiver are arranged to communicate between each other over a fixed delay short range wireless communication channel.

48. A combination as claimed in claim 46, wherein the communication channel is a Bluetooth communications channel.

49. A combination as claimed in claim 34, wherein the mobile communications device second wireless transceiver and the GPS wireless transceiver is at least one of:
a Bluetooth transceiver;
a IrDA transceiver;
a IEE 802.11 transceiver.

50. A combination as claimed in claim 34, wherein the at least the said timing information and location information comprises at least one of:
a base transceiver station timing signal;
a base transceiver station positional estimate.

51. A combination as claimed in claim 33, wherein the GPS device further comprises a connector and the mobile communications device further comprises a connector, wherein the GPS device connector is physically connected to the mobile device connector.

52. A mobile communications device of claim 31 wherein the mobile communications device wireless transceiver is at least one of:
a GSM transceiver;
a WCDMA transceiver;
a UMTS transceiver;
a CDMA2000 transceiver.

53. A GPS device as claimed in claim 32 further comprising an indicator, said indicator comprising at least one of:
at least one LED;
a buzzer.

54. A GPS device as claimed in claim 32, further comprising a switch arranged to switch said GPS device on and off.

55. A GPS device as claimed in claim 32, further comprising a battery arranged to provide a power source for said GPS device.

56. A method of providing a GPS estimate comprising the steps of:
receiving a GPS signal on a GPS device;
receiving at least one of timing information and location information from a cellular communications network on an mobile communications device, the mobile communications device being located at substantially the same location as the GPS device;
producing a further signal dependent on the said timing information and location information signal;
transmitting the further signal over a wireless communications link to the GPS device;
determining a positional estimate dependent on the received GPS signal and the third signal on the GPS device

57. A method as claimed in claim 56 further comprising the step of transmitting said determined positional estimate over the wireless communications link to the mobile communications device.

58. A method as claimed in claim 57 further comprising the steps of:
receiving the positional estimate on the mobile communications device via said wireless communications link;
displaying the received positional estimate on the mobile communications device.

59. A method as claimed in claim 57, further comprising the steps of;
storing the received positional estimate in a memory;
transmitting the stored positional estimate over the cellular communications network.

60. A combination as claimed in claim 33 wherein the mobile communications device wireless transceiver is at least one of:
a GSM transceiver;
a WCDMA transceiver;
a UMTS transceiver;
a CDMA2000 transceiver.
